(19) United States
(12) Patent Application Publication
(10) Pub. No.: US 2012/0001464 A1
(43) Pub. Date: Jan. 5, 2012

(54) VEHICLE SEAT COVER

(76) Inventors: Hwa Cheng Teoh, Kuala Lumpur (MY); Wah Leong Teoh, Kuala Lumpur (MY)

(21) Appl. No.: 13/256,970

(22) PCT Filed: May 26, 2009
(86) PCT No.: PCT/MY2009/000063

§ 371 Date: Sep. 16, 2011

(30) Foreign Application Priority Data
Mar. 18, 2009 (MY) PI 20091094

(51) Int. Cl. B60N 2/60; B23P 11/00

(52) U.S. Cl. 297/218.1; 29/428

(57) ABSTRACT

A method for attaching a vehicle seat cover (102a, 102b) onto an original cover of a vehicle seat (101) comprising a step of applying a detachable fixing means (105a, 105b, 105c) onto the outer surface (110) of the original cover of the vehicle seat (101) or the inner surface (107) of the vehicle seat cover (102a, 102b) or both at appropriate location and fixing the inner surface (107) of the vehicle seat cover (102a, 102b) closely onto the outer surface (110) of the original cover of the vehicle seat (101) such that the vehicle seat cover (102a, 102b) closely conforms to the contours of the vehicle seat (101).

### FIELD OF INVENTION

The present invention relates to a method for attaching a vehicle seat cover. In more particular, the present invention provides a method for attaching a vehicle seat cover closely onto a vehicle seat in which the vehicle seat cover is interchangeable and can be detachably fixed onto the vehicle seat to give a close fit.

### BACKGROUND OF THE INVENTION

Vehicle seats are usually made of low cost and durable materials, aiming to withstand as much beating as possible. Therefore, manufacturers or the end users of a vehicle, particularly car or truck, use a vehicle seat cover to protect the seat fabric and cushion as well as to beautify the appearance of the vehicle seat.

Vehicle seat cover is a great idea to prevent deleterious factors such as spilt dirts, wetness, friction or harsh sunlight from destroying the vehicle seat and thus increasing its durability. In addition, interchangeability of a vehicle seat cover is vital to promote hygiene in the internal environmental of the vehicle. Besides, it allows various designs of the vehicle seat covers for accommodating different lifestyles of a user.

Various types of interchangeable vehicle seat cover have been disclosed in the prior arts. U.S. Patent No. US2005130537 relates to a washable, stain-resistant vehicle seat cover which includes an upper portion and a lower portion. This vehicle seat cover is characterized by the elasticized flaps positioned near a lateral edge of a junction of a backrest and a seat cushion. The design of this cover aims to restrain spilt items from spilling onto other occupants or other area of the vehicle. There is no method disclosed on how to attach a vehicle seat cover onto the vehicle seat to obtain a close fit.

Another U.S. Pat. No. 4,019,776 also discloses a replaceable seat cover which can be attached onto an upholstered seat by means of a slide fastener. This design eases the engagement and disengagement of the seat cover but does not provide a close-fit between the seat cover and the seat as the pair of stringer tapes used is only capable of detachably attaching the periphery of the seat cover onto the seat.

Comfortability of the vehicle seat is also one of the main concerns of the users as a comfortable vehicle seat can promote driving safety. This main concern is not addressed by the prior arts. In order to enhance the level of comfortability of a vehicle seat, a close fit between the seat cover and the seat is desirable. Therefore, there is a need to develop an innovative method to attach a vehicle seat cover firmly onto a vehicle seat. This method shall be easy, convenient and does not affect the texture of the original cushion or fabric layer of the vehicle seat.

### SUMMARY OF INVENTION

The primary object of the present invention is to provide a method for attaching a vehicle seat cover onto a vehicle seat to get a close fit between the vehicle seat cover and the seat for preventing any twist and turn of the seat cover during a driving journey.

Another object of the present invention is to innovate a method for closely fitting a vehicle seat cover onto a vehicle seat without destroying the texture of the original cushion or fabric of the vehicle seat.

Still another object of the present invention is to provide a method for attaching a vehicle seat cover onto a vehicle seat which is simple and convenient for allowing interchangeability of various designs of the vehicle seat covers.

Yet another object of the present invention is to provide an interchangeable vehicle seat cover which can be closely attached onto the vehicle seat to give a better appearance to the vehicle seat and a more comfortable support to the driver or passenger of the vehicle at the backrest and seat base portion.

Further object of the present invention is to provide a vehicle seat cover which can be of various designs and comparable in quality yet low in production cost.

At least one of the preceding objects is met, in whole or in part, by the present invention, in which one of the embodiments of the present invention describes a method for attaching a vehicle seat cover (102a, 102b) onto an original cover of a vehicle seat (101) comprising a step of applying a detachable fixing means (105a, 105b, 105c) onto the outer surface (110) of the original cover of the vehicle seat (101) or the inner surface (107) of the vehicle seat cover (102a, 102b) or both at appropriate location and fixing the inner surface (107) of the vehicle seat cover (102a, 102b) closely onto the outer surface (110) of the original cover of the vehicle seat (101) such that the vehicle seat cover (102a, 102b) closely conforms to the contours of the vehicle seat (101).

Another embodiment of the present invention is a method for attaching a vehicle seat cover (102a, 102b) onto a vehicle seat (101) comprising a step of applying a detachable fixing means (105a, 105b, 105c) onto the outer surface (110) of the vehicle seat (101) or the inner surface (107) of the vehicle seat cover (102a, 102b) or both at appropriate location and fixing the inner surface (107) of the vehicle seat cover (102a, 102b) closely onto the outer surface (110) of the vehicle seat (101) such that the vehicle seat cover (102a, 102b) closely conforms to the contours of the vehicle seat (101).

According to the preferred embodiment of the present invention, the appropriate location for the mounting of the detachable fixing means (105a, 105b, 105c) is centre of the vehicle seat cover (102a, 102b).

In a preferred embodiment, the detachable fixing means (105a, 105b, 105c) is a hook-and-loop fastener (105a), a belt structure with buckles (105b), straps (105c), a double-sided adhesive or a combination of any two or more thereof. Optionally, the detachable fixing means (105a, 105b, 105c) can be applied through an attachment sheet (109).

Still another embodiment of the present invention is a vehicle seat cover (102a, 102b) applied on the original cover of a vehicle seat (101) using the method described in any one of the preceding embodiments.

Yet another embodiment of the present invention is a vehicle seat cover (102a, 102b) characterized by a detachable fixing means (105a, 105b, 105c) mounted on its inner surface (107) at appropriate location for detachably fixing the inner surface (107) of the vehicle seat cover (102a, 102b) closely onto outer surface (110) of a vehicle seat (101) or an original cover of the vehicle seat (101). Preferably, the appropriate location for the mounting of the detachable fixing means (105a, 105b, 105c) is centre of the vehicle seat cover (102a, 102b).

The vehicle seat cover (102a, 102b) as embodied herein can comprise a hook-and-loop fastener (105a), a belt structure with buckles (105b), straps (105c) or a double-sided adhesive as its detachable fixing means (105a, 105b, 105c). Likewise, the detachable fixing means (105a, 105b, 105c) can be applied through an attachment sheet (109).

Preferably, the vehicle seat cover (102a, 102b) is made up of a backrest cover (102a) and a seat base cover (102b).

Further embodiment of the present invention is a vehicle seat cover (102a, 102b) which is formed to conform to the contours of the vehicle seat (101).

The method disclosed is capable of providing a close fit between the vehicle seat cover (102a, 102b) and the seat (101) which gives a higher level of comfortability to the user, promote cleanliness and give a better appearance to the vehicle seat (101). This method allows the frequent engagement and disengagement of the vehicle seat cover (102a, 102b) without destroying the texture of the cushion and fabric layer of the vehicle seat (101).

One skilled in the art will readily appreciate that the present invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 shows the inner surface (107) of the backrest cover (102a) of a vehicle seat cover (102a, 102b) as described in one of the embodiments of the present invention; wherein the vehicle seat cover (102a, 102b) comprises a detachable fixing means (105a) mounted on the fitting lines (106) which fix the backrest cover (102a) closely onto the backrest (103) of the vehicle seat (101).

FIG. 2 is a backward view of the seat base cover (102b) of a vehicle seat cover (102a, 102b) which is mounted with a belt structure with buckles (105b) at its centre by sewing lines (111); in which the belt structure with buckles (105b) can fix the seat base cover (102b) closely onto the seat base (104) of the vehicle seat (101).

FIG. 3 shows the inner surface (107) of the seat base cover (102b) of a vehicle seat cover (102a, 102b) which is mounted with straps (105c) that fix the seat base cover (102b) closely onto the seat base (104) of the vehicle seat (101).

FIG. 4 is a front view of the vehicle seat (101) with its original cover on which the detachable fixing means (105a) is directly applied as described in another preferred embodiment of the present invention; wherein the outer surface (110) of the original cover is to be attached with the vehicle seat cover (102a, 102b) of FIG. 1.

FIG. 5 is a back view of the vehicle seat (101) of FIG. 4.

FIG. 6 is a front view of the vehicle seat (101) with its original cover on which the detachable fixing means (105a) is applied through an attachment sheet (109) as described in another preferred embodiment of the present invention; wherein the outer surface (110) of the original cover is to be attached with the vehicle seat cover (102a, 102b) of FIG. 1.

FIG. 7 is a back view of the vehicle seat (101) of FIG. 6.

FIG. 8 is a front perspective view of the vehicle seat (101) showing the fixing mechanism between the seat base cover (102b) having belt structure with buckles (105b) and the seat base (104) before the entire seat base cover (102b) is fixed thereon.

FIG. 9 is a bottom view of the vehicle seat (101) showing the fixing mechanism of the belt structure with buckles (105b) as the detachable fixing means as described in one of the preferred embodiments of the present invention.

FIG. 10 is a front view of the vehicle seat (101) showing the fixing mechanism between the seat base cover (102b) having straps (105c) and the seat base (104) before the entire seat base cover (102b) is fixed thereon.

FIG. 11 is a bottom view of the vehicle seat (101) showing the fixing mechanism of the straps (105c) as the detachable fixing means as described in one of the preferred embodiments of the present invention.

FIG. 12 is a backward view of the seat base cover (102b) of a vehicle seat cover (102a, 102b) which is mounted with a belt structure with buckles (105b) together with an attachment sheet (109) which is sewn at the centre of the seat base cover (102b) by sewing lines (111); in which the belt structure with buckles (105b) can fix the seat base cover (102b) closely onto the seat base (104) of the vehicle seat (101).

### DETAILED DESCRIPTION OF THE INVENTION

The present invention relates to a method for attaching a vehicle seat cover. In more particular, the present invention provides a method for attaching a vehicle seat cover closely onto a vehicle seat in which the vehicle seat cover is interchangeable and can be detachably fixed onto the vehicle seat to give a close fit.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention discloses a method for attaching a vehicle seat cover (102a, 102b) onto an original cover of a vehicle seat (101) comprising a step of applying a detachable fixing means (105a, 105b, 105c) onto the outer surface (110) of the original cover of the vehicle seat (101) or the inner surface (107) of the vehicle seat cover (102a, 102b) or both at appropriate location and fixing the inner surface (107) of the vehicle seat cover (102a, 102b) closely onto the outer surface (110) of the original cover of the vehicle seat (101) such that the vehicle seat cover (102a, 102b) closely conforms to the contours of the vehicle seat (101).

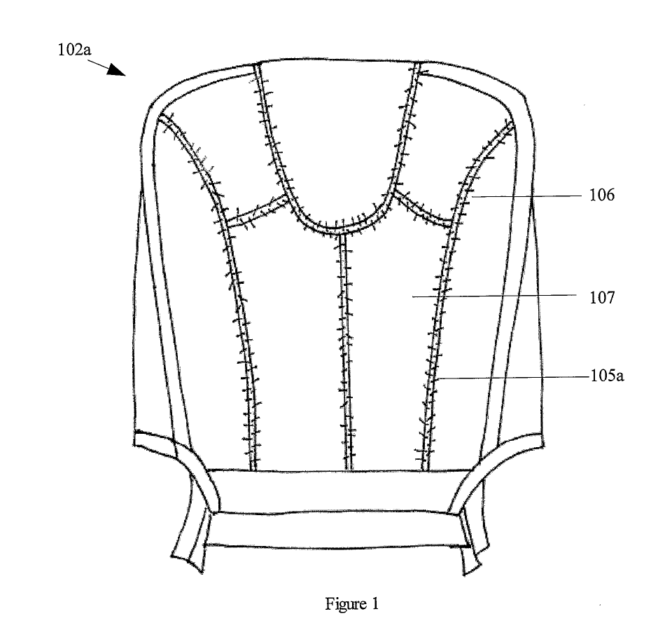

In accordance with the preferred embodiment of the present invention, different types of the vehicle seat cover (102a, 102b), as shown in FIGS. 1, 2 and 3, can be applied in this method to obtain a close fit between the vehicle seat cover (102a, 102b) and the vehicle seat (101) via the attachment between the inner surface (107) of the vehicle seat cover (102a, 102b) and the outer surface (110) of the original cover of the vehicle seat (101).

Another embodiment of the present invention is a method for attaching a vehicle seat cover (102a, 102b) onto a vehicle seat (101) comprising a step of applying a detachable fixing means (105a, 105b, 105c) onto the outer surface (110) of the vehicle seat (101) or the inner surface (107) of the vehicle seat cover (102a, 102b) or both at appropriate location and fixing the inner surface (107) of the vehicle seat cover (102a, 102b) closely onto the outer surface (110) of the vehicle seat (101) such that the vehicle seat cover (102a, 102b) closely conforms to the contours of the vehicle seat (101).

Preferably, the detachable fixing means (105a, 105b, 105c) used in the present method is a hook-and-loop fastener (105a), a belt structure with buckles (105b), straps (105c), a double-sided adhesive or a combination of any two or more thereof. The preferred hook-and-loop fastener (105a) can be commercially obtained under the trade name of Velcro. However, a person skilled in the art should appreciate the fact that other types of detachable fixing means available can also be applied in the present invention according to the preferred embodiment.

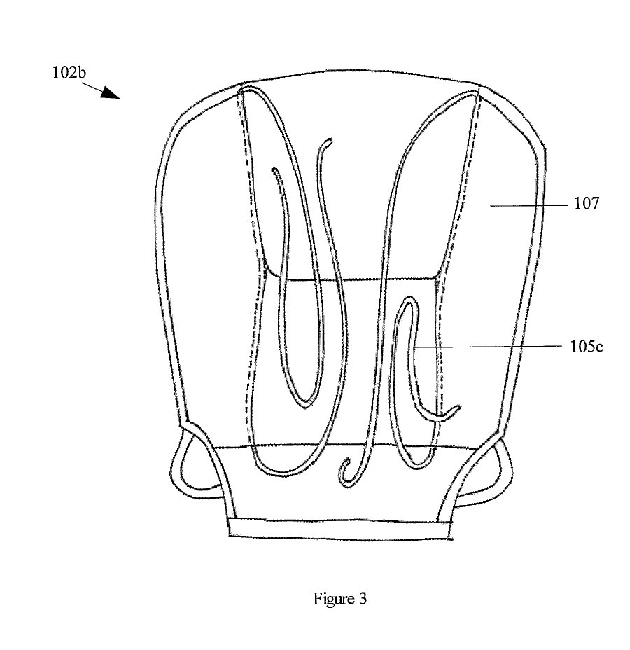

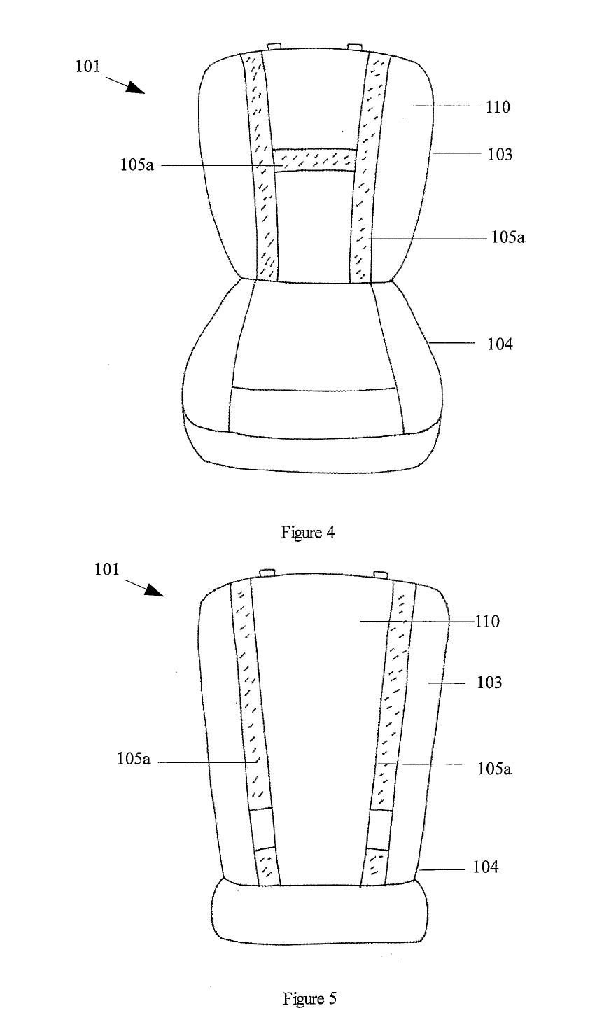

FIGS. 4 and 5 shows the attachment of the hook-and-loop fastener (105a) on the backrest (103) of a vehicle seat (101) as described in one of the preferred embodiments of the present invention. The front view is shown in FIG. 4 whereas the back view is shown in FIG. 5. The flat surfaces of these hook-and-loop fastener (105a) are attached onto the outer surface (110) of the backrest (103) at appropriate location without destroying the original cover of the vehicle seat (101) or the base cushion of the vehicle seat (101) according to another embodiment of the present invention. The original cover refers to the basic or original cover layer which has been readily attached to the outer surface (110) of the backrest (103) or seat base (104) of a vehicle seat (101) during the manufacturing process of the vehicle seat (101). This original cover can be made of fabric, polyvinylchloride (PVC) or even leather.

Preferably, the appropriate location for the mounting of the detachable fixing means (105a, 105b, 105c) is centre of the vehicle seat cover (102a, 102b). However, the present invention does not intend to limit the location of the detachable fixing means (105a, 105b, 105c) provided that it enhances the fitting of the vehicle seat cover (102a, 102b) onto the seat (101).

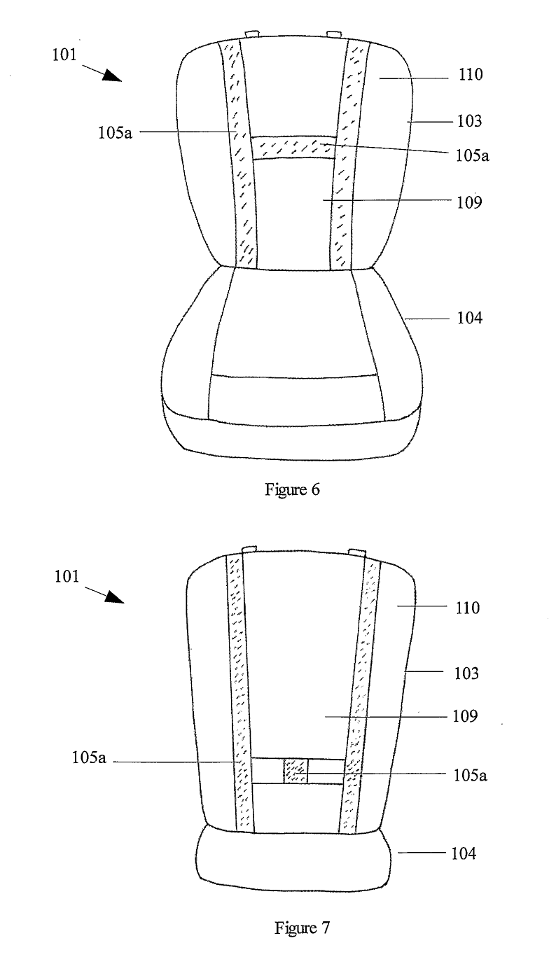

The hook-and-loop fastener (105a) can also be applied on the backrest (103) as a detachable fixing means via an attachment sheet (109). As illustrated in FIGS. 6 and 7, the attachment sheet (109) can be fitted closely onto the outer surface (110) of the backrest (103) with the hook-and-loop fastener (105a) sewed thereon. The attachment sheet (109) can be an additional layer of cloth or fabric which is used to aid the detachably fixing process of the hook-and-loop fastener (105a) onto the vehicle seat (101).

Accordingly, the backrest cover (102a) can be fixed onto the backrest portion (103) of the vehicle seat (101) by turning the backrest cover (102a) inside out as shown in FIG. 1, and attaching its inner surface (107) onto the outer surface (110) of the backrest (103) on which the detachable fixing means (105a) have been applied as shown in FIGS. 4 and 5 or FIGS. 6 and 7. The detachable fixing means (105a) applied on the backrest will attach to the detachable fixing means (105a) mounted on the fitting lines (106) of the inner surface (107) of the vehicle seat cover (102a, 102b). The fitting lines (106) also help to enhance the fitting. Trapped air can be eliminated by gently pressing the backrest cover (102a) onto the backrest (103) to obtain a close fit between the backrest cover (102a) and backrest (103) of the vehicle seat (101).

In accordance with another preferred embodiment of the present invention, the detachable fixing means (105a, 105b, 105c), including the hook-and-loop fastener (105a), a belt structure with buckles (105b), straps (105c), a double-sided adhesive or a combination of any two or more thereof are preferably applied on the inner surface (107) of the vehicle seat cover (102a, 102b) at appropriate location for fixing the vehicle seat cover (102a, 102b) onto the vehicle seat (101).

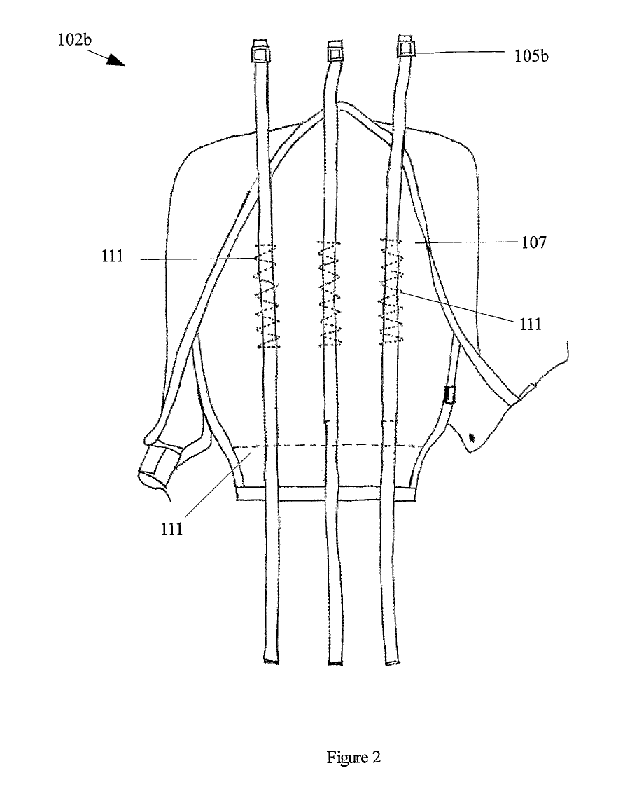

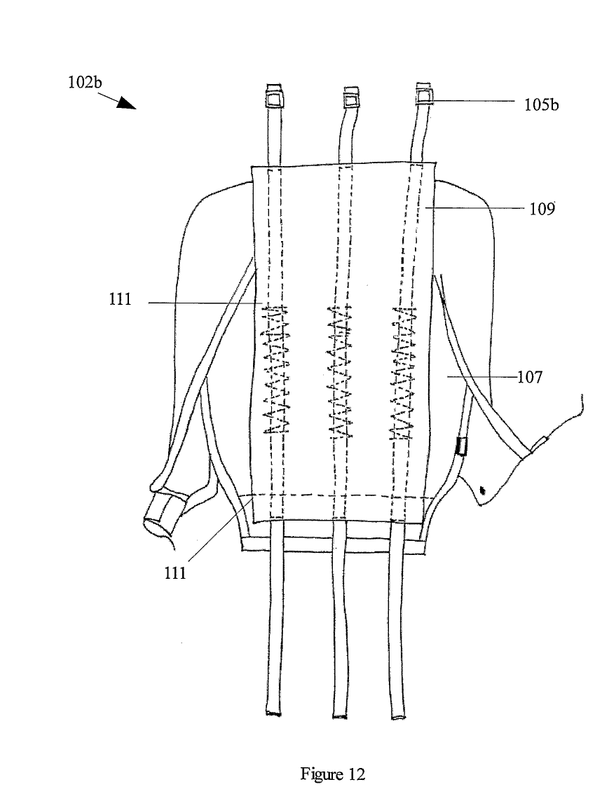

As illustrated in FIG. 2, the belt structure with buckles (105b) are mounted on the inner surface (107) of the seat base cover (102b) at the sewing lines (111). It is preferred that the attachments lie throughout the surface of the cover (102a, 102b) to ensure the close-fitting, and not at the periphery of the cover (102a, 102b). Therefore, the belt structure with buckles (105b) is sewn onto the vehicle seat cover (102a, 102b) at the centre of its inner surface (107). FIG. 2 shows an example of the three belts and buckles (102b) which are sewn at the sewing lines (111) on the inner surface (107) of the seat base cover (102b). In another preferred embodiment of the present invention, an attachment sheet (109), which is an additional layer of cloth or fabric as set forth in the preceding description can also be applied herein to fix the belt structure onto the inner surface (107) of the vehicle seat cover (102a, 102b). An example of this embodiment is shown in FIG. 12.

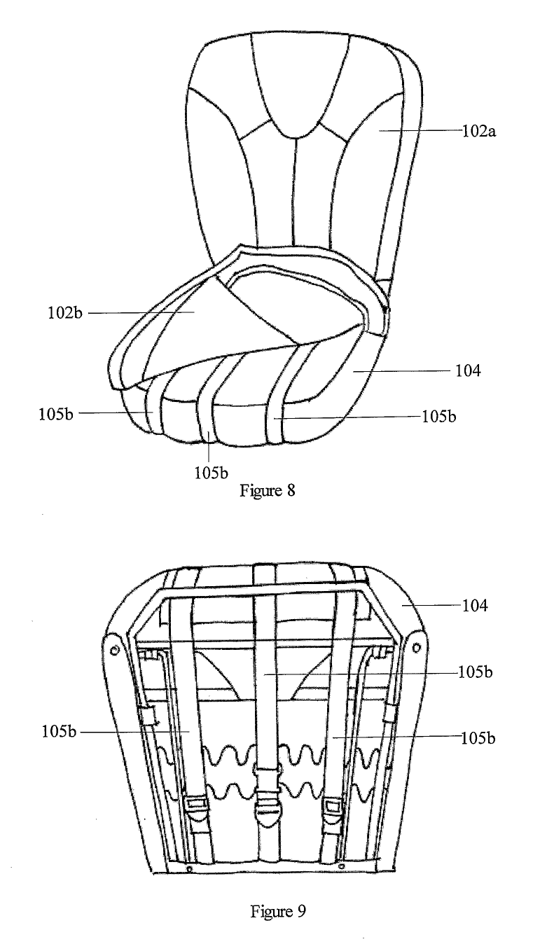

The fixing mechanism of the belt structure with buckles (105b) is shown in FIG. 8 and FIG. 9. Accordingly, the belts are tightened onto the original cover of the seat base (104) before the seat base cover (102b) can be fixed closely onto the seat base (104) to conform with the contour of the seat base (104). The buckles (105b) will be detachably fixed at the bottom of the seat base (104) as shown in FIG. 9.

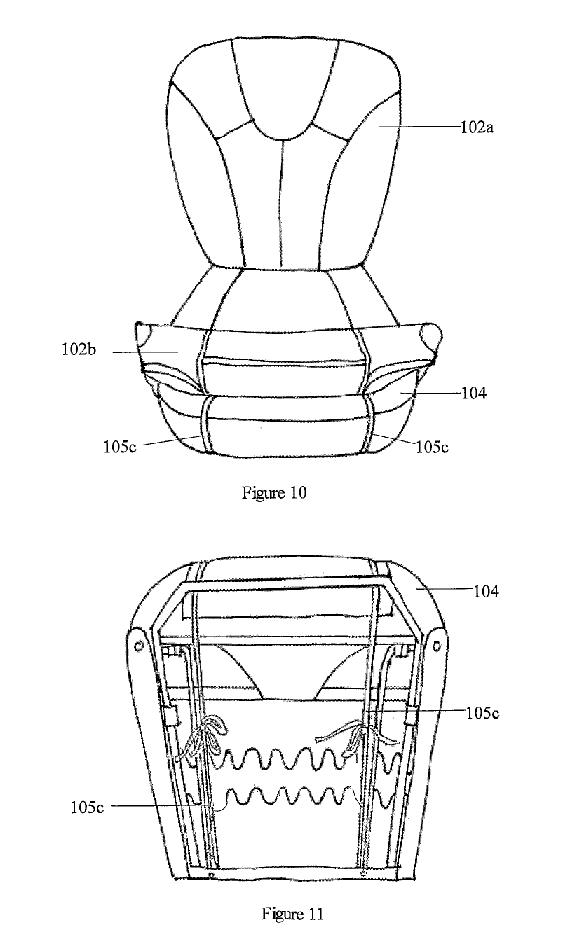

FIG. 3 shows another example of seat base cover (102b) with a different type of detachable fixing mechanism, which is the straps (105c). As described in one of the preferred embodiments, two long straps (105c) can be sewn onto the vehicle seat cover (102a, 102b) through the centre of its inner surface (107). As shown in FIG. 10, these straps (105c) tighten the inner surface (107) of the seat base (104) onto the original cover of the seat base (104) before the seat base cover (102b) can be fixed closely onto the seat base (104) in the similar manner to conform with the contour of the seat base (104). With reference to FIG. 10, the straps (105c) can be detachably fixed at the bottom of the vehicle seat (101). This fixing means (105c) can also be fixed directly onto the seat base (104) which is without any original cover.

Accordingly, the seat base cover (102b) can also be fixed onto the seat base (104) of the vehicle seat (101) in a similar manner as set forth in the foregoing description. The fitting can be adjusted and fixed by fastening the belt structure with buckles (105b) or tightening the straps (105c).

Still another embodiment of the present invention is a vehicle seat cover (102a, 102b) applied on a vehicle seat (101) using the method described in any one of the preceding embodiments.

The present invention also discloses a vehicle seat cover (102a, 102b) characterized by a detachable fixing means (105a, 105b, 105c) mounted on its inner surface (107) at appropriate location for detachably fixing the inner surface (107) of the vehicle seat cover (102a, 102b) closely onto outer surface (110) of the original cover of a vehicle seat (101).

As described in the preceding description, the detachable fixing means (105a, 105b, 105c) can be a hook-and-loop fastener (105a), a belt structure with buckles (105b), straps (105c), a double-sided adhesive or a combination of any two or more thereof. This vehicle seat cover (102a, 102b) is formed to conform to the contours of the vehicle seat (101) so that it can be closely fitted onto the vehicle seat (101), thus eliminating the bulky appearance of a covered vehicle seat (101).

Preferably, the vehicle seat cover (102a, 102b) is made up of a backrest cover (102a) and a seat base cover (102b). FIG. 1 shows the inner view of a backrest cover (102a) for the vehicle seat (101) with hook-and-loop fastener (105a). FIG. 2 and FIG. 3, respectively show the backward view and the inner surface of a seat base cover (102b), with a belt structure with buckles (105b) and straps (105c). As described in the preceding description, the detachable fixing means (105a, 105b, 105c) can be applied through an attachment sheet (109).

The vehicle seat cover (102a, 102b) can be made of various types of materials, such as waterproof neoprene, stain-resistant polyester or cotton, velour, leather, sheepskin or a combination of any two of more thereof. In the present invention, the most preferred materials used are leather and PVC.

The present disclosure includes as contained in the appended claims, as well as that of the foregoing description. Although this invention has been described in its preferred form with a degree of particularity, it is understood that the present disclosure of the preferred faun has been made only by way of example and that numerous changes in the details of construction and the combination and arrangements of parts may be resorted to without departing from the scope of the invention.

1-12. (canceled)

13. A method for attaching an interchangeable vehicle seat cover onto an original cover of a vehicle seat, comprising:
applying a detachable fixing system onto fitting lines of an inner surface of the vehicle seat cover by sewing the detachable fixing system thereon; and
fixing the inner surface of the vehicle seat cover closely onto the outer surface of the original cover of the vehicle seat such that the vehicle seat cover closely fits along the fitting lines facilitated by the detachable fixing system and conforms to the entire contours of the vehicle seat.

14. The method according to claim 13, wherein the detachable fixing system is sewn at the centre of the inner surface of the vehicle seat cover.

15. The method according to claim 13, wherein the detachable fixing system is a hook-and-loop fastener, a belt structure with buckles, straps, a double-sided adhesive or a combination of any two or more thereof.

16. The method according to claim 13, wherein the detachable fixing system is applied through an attachment sheet.

17. An interchangeable vehicle seat cover applied on a vehicle seat using a method according to claim 13.

18. An interchangeable vehicle seat cover, comprising:
a detachable fixing system which is sewn on fitting lines of an inner surface of the vehicle seat cover for detachably fixing the inner surface of the vehicle seat cover closely onto the outer surface of an original cover of the vehicle seat along the fitting lines, facilitated by the detachable fixing system, and to conform to the entire contours of the vehicle seat.

19. The interchangeable vehicle seat cover according to claim 18, wherein the detachable fixing system is sewn at the centre of the inner surface of the vehicle seat cover.

20. The interchangeable vehicle seat cover according to claim 18, wherein the detachable fixing system is a hook-and-loop fastener, a belt structure with buckles, straps, a double-sided adhesive or a combination of any two or more thereof.

21. The interchangeable vehicle seat cover according to claim 18, wherein the detachable fixing system is applied through an attachment sheet.

22. The interchangeable vehicle seat cover according to claim 18, further comprising a backrest cover and a seat base cover.
